(19) United States
(12) Patent Application Publication
(10) Pub. No.: US 2012/0204731 A1
(43) Pub. Date: Aug. 16, 2012

(54) GRILL

(76) Inventor: Young Whan Yu, Gyeonggi-do (KR)

(21) Appl. No.: 13/497,778

(22) PCT Filed: Sep. 15, 2010
(86) PCT No.: PCT/KR10/06316

§ 371 Date: Mar. 22, 2012

(30) Foreign Application Priority Data
Sep. 23, 2009 (KR) 10-2009-0090003

(51) Int. Cl. A47J 37/06

(52) U.S. Cl. 99/393

(57) ABSTRACT

The present invention relates to a grill where a grilled object hardly sticks to the grill in case meat, fish, and the like are grilled thereon. The present invention implements a novel form of a grill wherein a grill has a function of simply putting the object to be grilled on a heat source and a function such as heat conduction or heat storage is minimized by using a metal wire having a small diameter of 0.1-2.0 mm, a nonflammable fireproof fiber such as carbon or glass fiber, and the like, thereby providing a grill which is sanitary because the grilled object hardly sticks or burns thereon and the taste of the grilled object is improved as much as possible. The grill provided by the present invention can improve health by minimizing carbonization in case of grilling, can reduce the number of grills, the cost of labor, detergent and cleaning water, can maximize the taste of direct grilled objects, and can reduce manufacturing costs.

### TECHNICAL FIELD

The present invention relates to a grill used for grilling meat, fish, and others thereon, and more particularly, to a grill where a grilled object is hardly stuck to the grill.

### BACKGROUND ART

In general, a grill is unsanitary because a grilled object is easily stuck to the grill and is burned, and uses a wire with a thick diameter ranging from 2.0 mm to 10 mm for the sake of convenience in welding and manufacturing.

Such a grill is made of a metal material, such as copper, bronze, stainless steel, iron, and so on, and is manufactured through the steps of vertically and horizontally intercrossing or twisting wires and welding or tying and fixing ends of the intercrossed or twisted extension wires to a grill frame.

However, because the grilled object is stuck to the grill and burned while grilling and burned pieces of the grilled object become serious carcinogens, in order to avoid the grilled object burned, a user has to frequently replace with a new one while grilling, or sometimes inevitably eats burned foods.

Such a conventional grill using the wire with a thick diameter has elements unfit to be used as a grill as follows.

First, because the grill using the wire with the thick diameter is double the diameter of a grill using a wire with a small diameter in a contact area between the grilled objects and the grill, an area where grilled objects may be stuck to the grill increases when the grilled object is grilled. Moreover, because the grill using the wire with the thick diameter is as heavy as a duplicate ratio of the diameter when the grill has the same length as the grill using the wire with the small diameter, a storage of heat is also increased, so that the surface of the grilled object is easily stuck to the grill and carbonized when the grilled object is put on the grill.

Second, because the grill using the wire with the thick diameter is large in storage of heat and small in specific surface area, it keeps heat for a long time once the grill is heated up, and hence, the grilled object stuck to the grill will not come off well due to strong carbonization and stickiness.

Because of the above problem, some of restaurants which provide grilled foods use hydrochloric acid harmful to human bodies when the carbonized grills are washed or are equipped with a grill-washing system.

Third, in order to overcome the problems of the grill using the wire with the thick diameter, water grills have been developed and are circulating the market. In brief, the water grill keeps temperature of the surface of the grill within 100° C. by circulating water inside a metal grill pipe.

However, because water being larger in storage of heat than metal is circulated inside the metal pipe, the water grill has several problems in that it takes much time to grill the object, in that the grilled object is underdone because the portion where the grilled object is in contact with the grill is at low temperature, and in that manufacturing costs are high because a water circulation structure is complex.

Fourth, in order to overcome the problems of the grill having the wire with the thick diameter, there are Korean Patent No. 0429593 and Korean Utility Model Registration Nos. 0185641 and 0285055. The prior arts have common features in that an area that the grilled object is stuck to the grill is minimized because an upper part of the grill where the grilled object is in contact with the grill is sharpened. However, the prior arts can initially prevent the grilled object from being stuck to the grill but finally there is little difference between the grill having the wire with the thick diameter and the prior arts. The reasons are as follows.

1. The grilled object is burned and stuck to the grill as time passes because the object is grilled at high temperature in a state where the grill stores much heat as the grill is heavy weighted.

2. Because the portion of the grill which is in contact with the grilled object is small in the contact surface but the other portion of the grill excepting the contact portion is wide, when the grilled object reaches at the boiling point, meat juices flowing out from the grilled object are stuck to every narrow and deep portion of sides of the grill and burned as they are, and hence the prior arts are not a fundamental solution.

3. When the grilled object is directly grilled on fire, it requires a wide area that the grilled object is exposed to a heat source. However, in the case of the grills according to the prior arts, because the exposed area is small, the grilled object is cooked slowly, and hence, the meat juices are dried and the meat becomes tough and doesn't taste good hence less incense permeates the grilled object.

### DISCLOSURE

### Technical Problem

Accordingly, the present invention has been made in an effort to solve the above-mentioned problems occurring in the prior arts, and it is an object of the present invention to provide a novel form of a grill, which is used to simply put an object to be grilled on a heat source and minimizes functions such as heat conductivity and heat storage of the grill by using a wire with a small diameter ranging from 0.1 mm to 2.0 mm, thereby being sanitary because the grilled object is little stuck to the grill or burned and maximizing the taste of grilled foods.

### Technical Solution

To achieve the above objects, the grill according to the present invention provides the following characteristics.

First, the grill according to the present invention uses a wire with a small diameter.

Differently from the grills according to the prior arts, the grill according to the present invention is used to simply put an object to be grilled on a heat source and minimizes functions such as heat conductivity and heat storage of the grill.

Because the grill using the wire with the small diameter is in less contact with the grilled object, the grilled object is less likely to be stuck to the grill and burned. Furthermore, the grilled object has much exposure to a heat source, and hence, the object is cooked rapidly and provides a good and soft taste because meat juices are not dried and the grilled object is saturated with much incense.

In fact, compared with the grill using the wire with the thick diameter, the grill using the wire with the small diameter has the specific surface area, which is reduced as less as a duplicate ratio of the diameter of the wire, and hence, the area that the grilled object is stuck to the grill is reduced and a probability that the grilled object is burned is also reduced.

When the wire diameter is small, a curvature of a cross section is reduced and the grilled object is not in side contact but in tiny line contact with the grill, and hence, the grilled object prevents a direct fire heat transferred from the heat source to the grill because the grill is buried under the surface of the soft grilled object, so that temperature of the grill becomes similar to temperature of the grilled object and the grilled object is less stuck to the grill and burned less.

In conditions of the same materials and the same length, storage of heat is proportional to the square of the diameter of the grill.

In order to prevent temperature of the grill from rising rapidly and keeping high temperature, the storage of heat must be minimized, but because the storage of heat is proportional to weight, a thin grill which is light is small in storage of heat.

Most of food materials to be grilled are cooked after being stored in refrigerator or at room temperature. So, in the case of the grill using the wire having a small diameter, because the grill is very small in storage of heat even though the grill is previously heated to high temperature, heat stored in the grill is rapidly moved to the grilled object and the grill is rapidly cooled. Accordingly, because the grilled object is cooked in a state where the object and the grill are in heat balance at similar temperature while grilling, the grilled object is not stuck to the grill and is not burned.

Because an area where the grilled object is exposed to the heat source is increased when the diameter of the wire gets thinner, the grilled object can be grilled rapidly, meat juices are not dried, and the object becomes tender.

Particularly, when charcoal or firewood is used as a heat source, an area where incense gets in contact with the surface of the grilled object is increased, and so, the grilled object provides a good taste of grilled food.

The present invention is characterized in that strands of the wire of a tiny diameter are arranged just in one direction without crossing. Like the grills according to the prior arts, when the wires cross vertically or horizontally or in two directions, small pieces or juices of grilled object are frequently attached and stuck to the crossing portions and then burned.

Moreover, as described above, in the case of the grill having wires crossing vertically and horizontally, because thermal capacity gets increased by weight of the grill and the surface exposed to the heat source is small, the grilled object is cooked slowly, and hence, meat juices are dried and burned and stuck to the grill.

In order to minimize a contact area between the grilled object and the grill, a cross section of the wire used in the grill may be in one of various shapes having sharp contact points as well as in a round shape.

In the present invention, because multiple strands of the wire having the tiny diameter are arranged without crossing and ends of the wires are not welded or tied to the grill frame, the grill may be made of one of various materials.

For instance, the grill may be made not only of a metal material like the prior arts but also of inorganic materials, such as carbon fiber and glass fiber, which are low in heat conductivity and heat capacity and are soft and economical fire-proof incombustible materials.

Second, the grill according to the present invention supports the grilled object through various types of a wire elasticity regulating structure.

Because the grill according to the present invention uses the wire of the tiny diameter, the wire is pulled as much as possible in order to prevent the wire from becoming loose and provide elasticity to the wire.

The grill may include a wire feeder and a wire winder mounted at both ends of the wire in order to regulate elasticity of the wire by rotating at least one grill to which the wire is caught, to supply and wind the wire, and to regulate elasticity of the wire by rotating the feeder and the winder in forward and backward directions.

Furthermore, the grill may includes two divided grill frames to which the wire is caught, and a tension or compression spring or a bolt-and-nut portion disposed between the two divided grill frames in order to increase or decrease a distance between the two divided grill frames and to regulate elasticity of the wire.

Additionally, the wire has a screw portion which is formed at one end thereof and a head portion which is formed at the other end thereof and larger than the diameter of the wire, and the grill frame has a plurality of through holes formed in a side of the grill frame in such a fashion that the diameter of the wire passes therethrough but the head portion cannot pass therethrough. After that, the wires of multiple strands are inserted into the through holes and the screw portion is tightened by a nut, whereby elasticity of the wire can be regulated.

In the above example, a tension spring is mounted in place of the screw portion and is inserted into the grill frame, so that elasticity of the wire can be regulated using the spring.

Furthermore, a thermal expansion material, which is larger in thermal expansion than the grill frame, is mounted on the bottom face of the divided grill frame facing the heat source, and hence, elasticity of the wire can be regulated in a manner that the thermal expansion material is expanded while grilling.

Third, the grill according to the present invention can withdraw the wire polluted while grilling and feed a new wire.

Because the wire used in the present invention can be wound because it is thin and flexible, when one or two grill frames (rotary shafts) on which the wire is wound are rotated, the polluted wire is wound onto the other grill frame and a new wire is supplied. Alternatively, a wire feeder for supplying a clean wire is mounted at an end of the wire and a wire receiver for receiving and withdrawing the used wire is mounted at the other end of the wire, so that the polluted wire is withdrawn by a rotation of the wire receiver and a new wire is supplied by a rotation of the wire feeder when the wire is polluted while grilling, and hence, the grill according to the present invention is convenient, sanitary and economical.

### Advantageous Effects

The grill according to the present invention provides the following merits.

First, the grill contributes to promotion of health by minimizing carbonization of the grilled object while grilling.

1. The grill is sanitary because the grilled object is less stuck to the grill and is minimized in carbonization.

The results of clinical tests that eating of burned foods is one of serious causes of carcinogenesis have been announced one after another. So, the grill according to the present invention contributes to promotion of health because a user does not eat carbonized foods stuck to the grill when the user uses the grill according to the present invention.

2. The grill according to the present invention can prevent cooks' or users' respiratory diseases because the grill minimizes smoke generated while grilling.

Most of smoke generated while grilling is generated on a heated grill, but because the grill according to the present invention generates little smoke, the grill can prevent respiratory diseases of the cooks or users.

3. If necessary, a new grill is provided easily, and hence, the grill is convenient in use.

Particularly, in the case of restaurants, when it is full of customers, due to limited conditions, it is not easy to frequently replace the used grill with a clean and new one, and hence, the users may use unsanitary or carbonized grills, which are roughly washed with an iron brush. However, if the thin and soft grill according to the present invention is used, the cooks can simply and easily put the carbonized grill to a receiving hole or a receiving frame and, at the same time, easily take a clean grill from a supply frame, and hence, the grill according to the present invention is convenient in use and sanitary.

Second, the grill according to the present invention can reduce the number of used grills, labor costs, an amount of used detergent, and an amount of cleaning water.

1. The number of grills stored or replaced can be reduced.

Because the grill must be frequently replaced with a new one when the grilled object is frequently stuck to the grill, grills are required as much and frequent replacement causes time consumption and financial consumption.

In the case of restaurants, in order to roast the object on a clean grill, it is varied with the number of customers per a table, but generally, grills are replaced with a new one four or five times, and hence, the restaurants have a great expense in initial stockpile of the grills.

2. Labor costs can be reduced.

In the case of the grill according to the present invention, there is little need to replace the grill, labor costs for washing and replacement of the grill can be reduced greatly.

Particularly, in the case of restaurants, compared with the grills according to the prior arts, the grill according to the present invention can reduce the labor costs by ¼ to ⅕.

3. Used amounts of detergent and cleaning water can be reduced.

In the case of the typical grills using metal wires with a diameter ranging from 2.0 mm to 10 mm, it is necessary that four or five grills are washed per one table, and hence, it causes environmental pollution and abuse of water resource due to the use of a lot of detergent and cleaning water.

But, the grill according to the present invention is eco-friendly because it can be washed cleanly by using ⅕ to ¼ of the used amounts of detergent and cleaning water.

Third, the grill according to the present invention can maximize the taste of directly grilled food.

People prefer directly grilled food to indirectly grilled food because they enjoy tender bits and incense of juicy meat.

Particularly, in the case of directly grilled food such as charcoal-grilled food or firewood-grilled food, because an area where the grilled object is exposed to the heat source is large and the grilled object is grilled rapidly due to a lot of radiant exposure of far infrared rays and incense, meat is not dried and becomes juicy so that people can enjoys tender bits and good taste of smoked food.

Because the grill according to the present invention uses the wires of a tiny diameter, which do not cross at right angles, the area where the grilled object is exposed to the heat source is large, and hence, it maximizes the taste of the grilled food.

Fourth, the grill according to the present invention can reduce manufacturing costs.

1. Manufacturing costs are remarkably reduced because one way wires of a tiny diameter are used.

In an aspect of material costs, when the wires of the diameter ranging from 0.1 mm to 2.0 mm of similar length are used rather than the wires of the diameter ranging from 2.0 mm to 10 mm, the material costs can be reduced by a difference between duplicate ratios of the wire diameters.

2. The grill according to the present invention does not need the process to weld, intercross, or twist the wires, or tie the wires to the grill frame, and the wire of a straight line is wound and fixed at support rods or a rotational support frame, and hence, the manufacturing process is simple and the manufacturing cost is inexpensive.

Fifth, the grill according to the present invention may be made of an inorganic material, such as carbon fiber or glass fiber.

The grill according to the present invention uses a soft wire with a tiny diameter. Because a front end of the wire is not welded or tied to the grill frame when the front end of the wire is fixed to the grill frame, not only metal materials but also fire-proof incombustible materials, such as carbon fiber or glass fiber, which is small in heat conductivity and heat storage and is economical, and hence, the grilled object is little stuck to the grill and there is no risk of carbonization of food.

### DESCRIPTION OF DRAWINGS

FIGS. 1 and 2 are schematic diagrams of a grill according to a first preferred embodiment of the present invention.

FIGS. 3 and 4 are schematic diagrams of a grill according to a second preferred embodiment of the present invention.

FIGS. 5 and 6 are schematic diagrams of a grill according to a third preferred embodiment of the present invention.

FIGS. 7 to 10 are schematic diagrams showing various forms of support rods of the grill according to the present invention.

FIG. 11 is a schematic diagram showing various cross sections of a wire of the grill according to the present invention.

FIGS. 12 and 13 are schematic diagrams of a grill according to a fourth preferred embodiment of the present invention.

FIGS. 14 and 15 are schematic diagrams of a grill according to a fifth preferred embodiment of the present invention.

FIGS. 16 and 17 are schematic diagrams of a grill according to a sixth preferred embodiment of the present invention.

FIGS. 18 and 19 are schematic diagrams of a grill according to a seventh preferred embodiment of the present invention.

FIGS. 20 and 21 are schematic diagrams showing an example of a wire elasticity regulator of the grill according to the present invention.

FIGS. 22 to 24 are schematic diagrams showing another example of a wire elasticity regulator of the grill according to the present invention.

FIG. 25 is a schematic diagram showing a further example of the wire elasticity regulator of the grill according to the present invention.

FIGS. 26 and 27 are schematic diagrams showing a still further example of the wire elasticity regulator of the grill according to the present invention.

FIGS. 28 and 29 are schematic diagrams showing another example of the wire elasticity regulator of the grill according to the present invention.

FIGS. 30 and 31 are schematic diagrams showing a further example of the wire elasticity regulator of the grill according to the present invention.

FIGS. 32 and 33 are schematic diagrams showing a still further example of the wire elasticity regulator of the grill according to the present invention.

FIG. 34 is a schematic diagram of a grill according to an eighth preferred embodiment of the present invention.

FIGS. 35 to 37 are schematic diagrams showing another example of the wire elasticity regulator of the grill according to the present invention.

FIGS. 38 and 39 are schematic diagrams showing a further example of the wire elasticity regulator of the grill according to the present invention.

FIGS. 40 and 41 are schematic diagrams of a grill according to a ninth preferred embodiment of the present invention.

### MODE FOR INVENTION

Reference will be now made in detail to the preferred embodiments of the present invention with reference to the attached drawings.

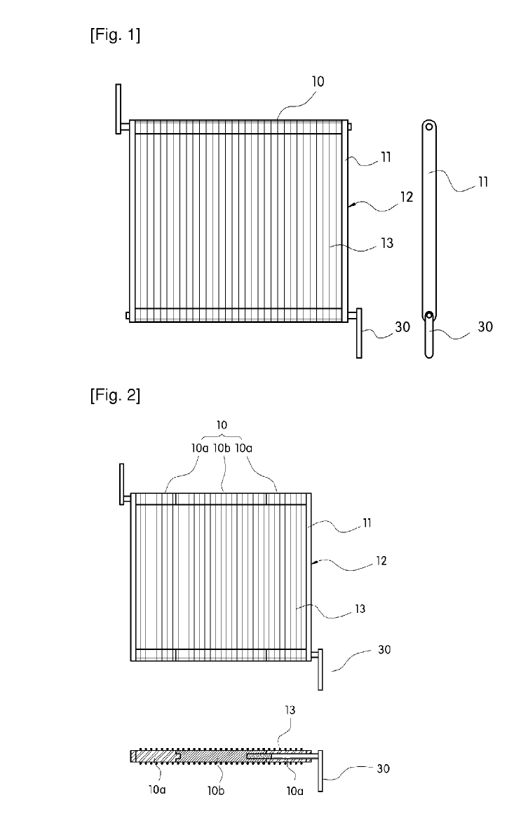

FIGS. 1 and 2 are schematic diagrams of a grill according to a first preferred embodiment of the present invention.

As shown in FIGS. 1 and 2, wires 13 are wound on rotary shafts 10.

The grill according to the present invention includes a grill frame 12 of a rectangular shape having two support frames and two rotary shafts 10, and the wires 13 of multiple strands arranged side by side in one direction and space apart from one another at regular intervals are mounted between the two rotary shafts 10.

The rotary shafts 10 are joined between the support frames 11 in such a fashion that both ends are rotatable, and each of the wires 13 are wound on one or both of the rotary shafts 10 several times.

For instance, not shown in the drawings in detail, but each of the rotary shafts 10 may have a groove (not shown) formed on the outer circumferential surface thereof and the wires 13 of a small diameter may be wound on the groove several times. In this instance, both ends of the wire 13 may be tied and fixed to the shaft, or a groove (not shown) is formed on the shaft in a diameter direction and the ends of the wire 13 are inserted into the groove, and then, a cap is fit and fixed to the groove.

Moreover, a handle 30 is provided as means to rotate the rotary shaft 10, and is caught to one end of the rotary shaft 10.

In this instance, the handle 30 may be used in a state where it is fixed to the rotary shaft 10.

Particularly, the wire 13 may be made of one of metal material, inorganic material containing fire-proof incombustible fiber, such as carbon fiber or glass fiber, and others. The wire 13 has a small diameter within a range of 0.1 mm to 2.0 mm, so that the grill can prevent the grilled object from being burned or stuck to the grill.

Accordingly, when a user wants to replace the wire 13 with a new one due to pollution of the wire while grilling, the user rotates the handle 30. Then, the polluted wire 13 is wound on one of the rotary shafts 10, and a clean wire 13, which is wound on the other rotary shaft 10, is released and newly arranged on the whole face of the grill frame 12, and hence, the wire 13 can be easily replaced with a new and clean wire.

As another example of the first preferred embodiment, as shown in FIG. 2, the wire 13 may be partially replaced with a new one.

For instance, the rotary shaft 10 includes three portions: fixed portions 10a formed in both side sections; and a rotational portion 10b formed in a central section between the side sections, and in the above structure, when a user rotates the handle 30, just the rotational portion 10b of the central section is rotated.

In other words, most of the grilled object is severely polluted at the central portion of the heat source, and hence, when the user rotates the handle 30 in order to replace the polluted wire 13 with a new one, only a portion of the wire 13 located at the central portion of the heat source is moved between the rotary shafts 10 and replaced with a clean wire 13.

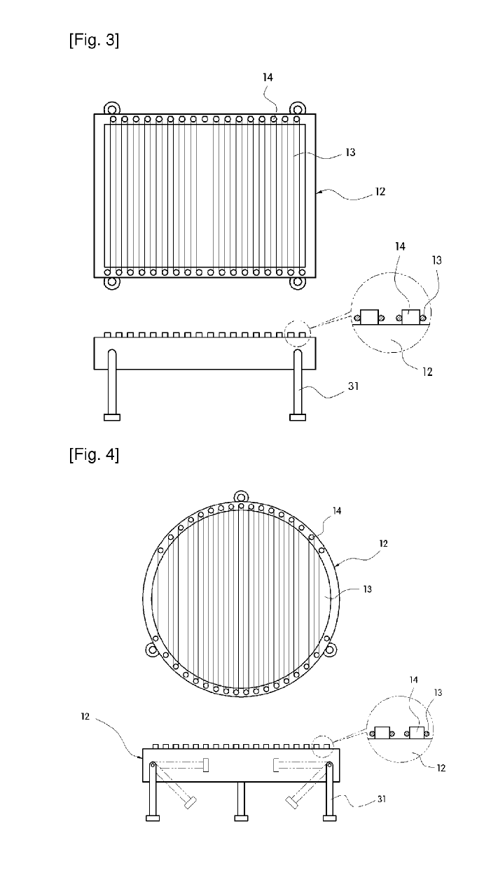

FIGS. 3 and 4 are schematic diagrams of a grill according to a second preferred embodiment of the present invention.

FIG. 3 illustrates a grill taking a form that a wire 13 of one strand is continuously wound on support rods 14.

The grill includes a grill frame 12 of a rectangular shape and a plurality of the support rods 14 arranged on two opposite sides out of four sides of the grill frame 12 at regular intervals along a longitudinal direction of the sides.

Additionally, the grill further includes support bars 31 mounted on the grill frame 12 in order to keep the grill frame 12 at a predetermined height from the heat source.

The wire 13 of one strand is caught to the support rods 14, which are located at the two sides of the grill frame 12, in a zigzag pattern while advancing from one side to the other side of the grill frame 12, so that the wire 13 shows a form that many strands are arranged side by side at regular intervals.

In this instance, an end portion of the wire 13 is fastened to the grill frame 12 or to the outermost support rods 14 in such a fashion that the end portions of the wire 13 are tied to the grill frame or the outermost support rods 14 or in such a fashion that the end portions of the wire 13 are inserted into a groove, which is formed in the support rods, and the groove is covered with a lid.

As shown in FIG. 4, in the case that the grill frame 12 is formed in a round shape, a plurality of the support rods 14 are mounted on specific opposite sections of a round rim of the grill frame 12, and the wire 13 of one strand is caught to the support rods 14 of each section in a zigzag pattern while advancing from one side to the other side of the grill frame 12, so that the wire 13 shows a form that many strands are arranged side by side at regular intervals.

In this instance, the support bars 31 disposed on the grill frame 12 of the round shape are mounted in a rotatable manner and are foldable and unfoldable, and can keep a proper height by being adjusted at proper angles so that the grilled object is cooked at moderate temperature.

Of course, also in the second preferred embodiment, the wire 13 may have a small diameter within a range of 0.1 mm to 2.0 mm, and be made of one of metal material, inorganic material containing fire-proof incombustible fiber, such as carbon fiber or glass fiber, and others.

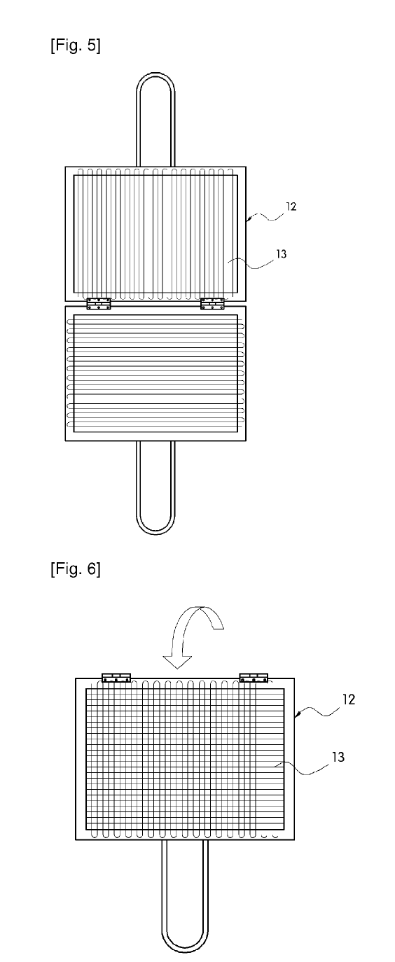

FIGS. 5 and 6 are schematic diagrams of a grill according to a third preferred embodiment of the present invention.

FIGS. 5 and 6 illustrate a foldable grill having two grills which are foldable and unfoldable.

A pair of grill frames 12 are connected with each other by hinges, and a wire 13 of one strand is mounted on the grill frame 12 in such a fashion that the wire 13 is caught to support rods 14, which are located at two sides of the grill frame 12, in a zigzag pattern while advancing from one side to the other side of the grill frame 12, so that the wire 13 shows a form that many strands are arranged side by side at regular intervals. Alternatively, wires 13 of multiple strands are arranged between the two opposite sides of the grill frame 12 side by side in one direction at regular intervals.

Particularly, when the grill frames 12 are combined together in order to prevent the grilled object from getting out through gaps between the strands of the wire, the strands of the wire 13 put on each grill frame may be arranged in a direction that the strands cross at angles of 90°.

Of course, also in the third preferred embodiment, the wire 13 may have a small diameter within a range of 0.1 mm to 2.0 mm, and be made of one of metal material, inorganic material containing fire-proof incombustible fiber, such as carbon fiber or glass fiber, and others.

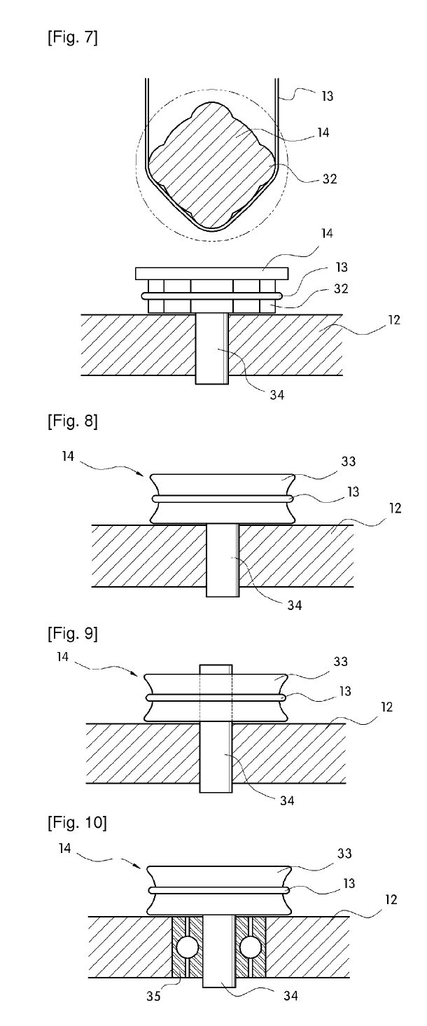

FIGS. 7 to 10 are schematic diagrams showing various forms of the support rods of the grill according to the present invention.

As shown in FIGS. 7 to 10, for smooth sliding and tension of the wire 13, the structure and form of the support rods 14 to which the wire 13 is caught are very important.

FIG. 7 illustrates a support rod 14 fixed to the grill frame 12. In order to minimize friction of the wire 13, each of the support rods 14 has a plurality of projections 32 formed on the circumferential surface of the cylindrical rod, and the wire 13 is wound on the projections 32.

FIG. 8 illustrates a support rod 14 which has a shaft 34 and a roller 33 integrated with each other. In FIG. 8, the support rod 14 is rotatably mounted on the grill frame 12 using the shaft 34. The circumferential face of the roller 33 is in a concave form, and the wire 13 is wound on the concave portion of the roller 33.

FIG. 9 illustrates a support rod 14 taking the form that a rotatable roller 33 is joined to a shaft 34 fixed to the grill frame 12. FIG. 10 illustrates a support rod 14 utilizing a bearing 35 mounted on the grill frame 12 in order to promote rotation through a small friction.

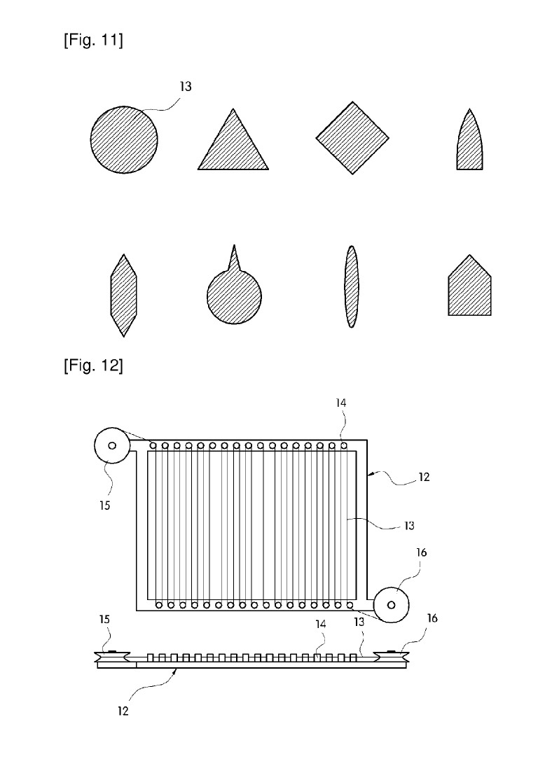

FIG. 11 is a schematic diagram showing various cross sections of a wire of the grill according to the present invention.

As shown in FIG. 11, fundamentally, the grilled object has a low risk of being stuck to the grill when a contact surface between the grilled object and the wire 13 is small.

Accordingly, in the present invention, the wire 13 may adopt one of various cross section shapes, such as a round, a triangle, a diamond, a gimlet shape, a hexagon, a combination of a round and a thin plate, an oval, a pentagon, a polygon, and other shapes.

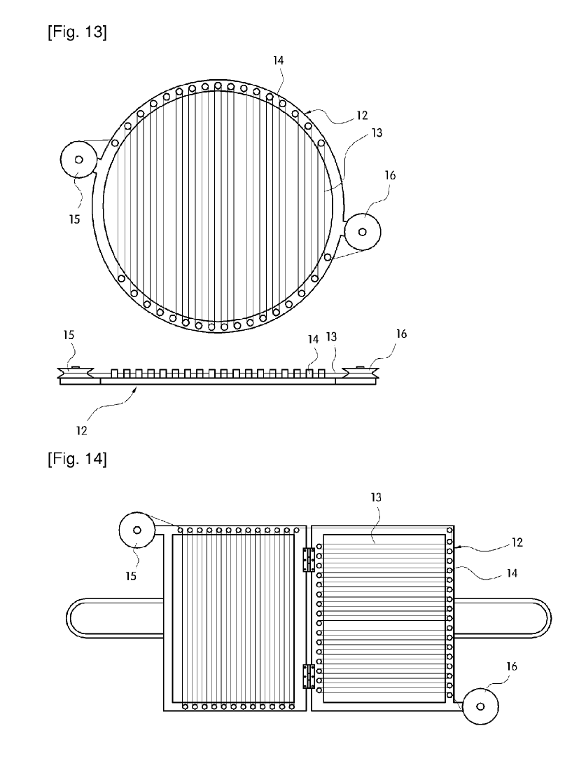

FIGS. 12 and 13 are schematic diagrams of a grill according to a fourth preferred embodiment of the present invention.

FIGS. 12 and 13 illustrate a grill having a structure that the wire 13 is supplied to one side of the grill and the wire 13 is withdrawn from the other side.

The grill according to the fourth preferred embodiment of the present invention includes a grill frame 12 of a rectangular or round shape, a rotational feeder 15 mounted at one side of the grill frame 12 for releasing and supplying the wire 13, and a rotational winder 16 mounted at the other side of the grill frame 12 for winding and withdrawing the wire 13.

In this instance, the feeder 15 and the winder 16 are all in a concave shape at central portions of their circumferential faces so as to prevent the wire 13 from being separated.

Moreover, the wire 13 continuously extending between the feeder 15 and the winder 16 is caught to a plurality of support rods 14, which are mounted on both opposite sides (in the case of the rectangular shape) or both opposite sections (in the case of the round shape) of the grill frame 12, in a zigzag pattern, so that the wire 13 shows a form that many strands are arranged side by side all over the entire area of the grill frame 12.

In other words, the wire 13 released from the feeder 15 is arranged all over the entire area of the grill frame 12, and then, wound on the winder 16.

Here, the feeder 15 and the winder 16 may include a rotation controller (not shown), such as a stopper, a clutch bearing, a racket gear, or others in order to control the length and position of the wire 13 when the wire 13 is released or wound.

Also in the fifth preferred embodiment, the wire 13 may have a small diameter within a range of 0.1 mm to 2.0 mm, and be made of one of metal material, inorganic material containing fire-proof incombustible fiber, such as carbon fiber or glass fiber, and others.

Furthermore, as shown in FIGS. 16 and 17, if the grill has a large size, it will not be easy to move the wire 13 using just one set of the feeder 15 and the winder 16 because a friction between the support rods 14 and the wire 13 is great.

In the above instance, it is preferable that at least one guide roller 17 supported on the grill frame 12 is mounted in a movement path of the wire 13 to promote the movement of the wire 13.

Accordingly, in order to replace the used and polluted wire of the grill with a new one, when the user winds only the winder 16 or winds the winder 16 while releasing the feeder 15, the wire 13 wound on the feeder 15 moves all over the entire area of the grill frame 12, and then, the polluted wire 13 mounted all over the entire area of the grill frame 12 is wound on the winder 16 to be withdrawn, and hence, the user can easily replace the used wire 13 with a new one.

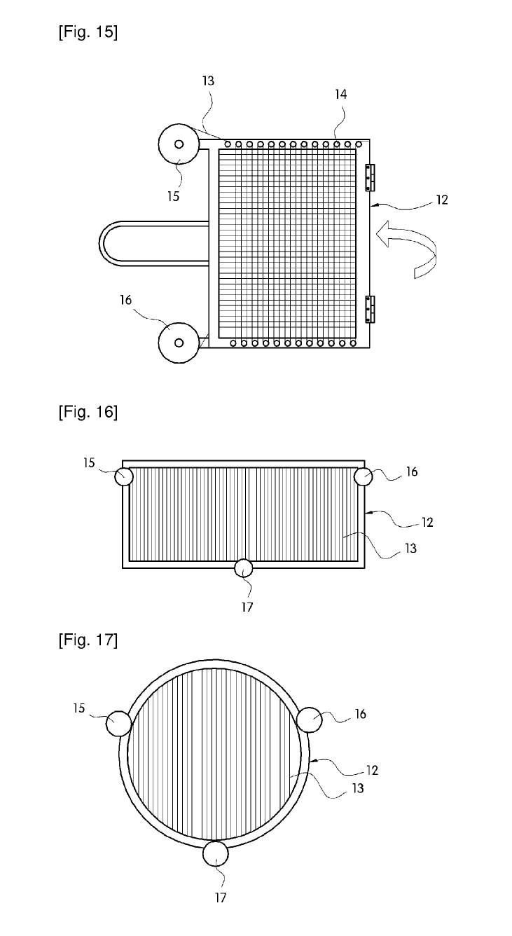

FIGS. 14 and 15 are schematic diagrams of a grill according to a fifth preferred embodiment of the present invention.

FIGS. 14 and 15 illustrate a foldable grill having a feeder 15 and a winder 16.

A pair of grill frames 12 are connected with each other by hinges and includes the feeder 15 and the winder 16, and a wire of one strand released from the feeder 15 is caught to a plurality of support rods 14, which are located at one of two grill frames, in a zigzag pattern while advancing from one side to the other side of the grill frame 12, so that the wire 13 shows a form that many strands are arranged side by side at regular intervals. After that, the wire 13 is also mounted at the other grill frame 12 in the same way, and then, is wound on the winder 16 mounted on the grill frame 12.

In this instance, when the grill frames 12 are combined together in order to prevent the grilled object from getting out through gaps between the strands of the wire, the strands of the wire 13 put on each grill frame may be arranged in a direction that the strands cross at angles of 90°.

Also in this embodiment, the wire 13 may have a small diameter within a range of 0.1 mm to 2.0 mm, and be made of one of metal material, inorganic material containing fire-proof incombustible fiber, such as carbon fiber or glass fiber, and others.

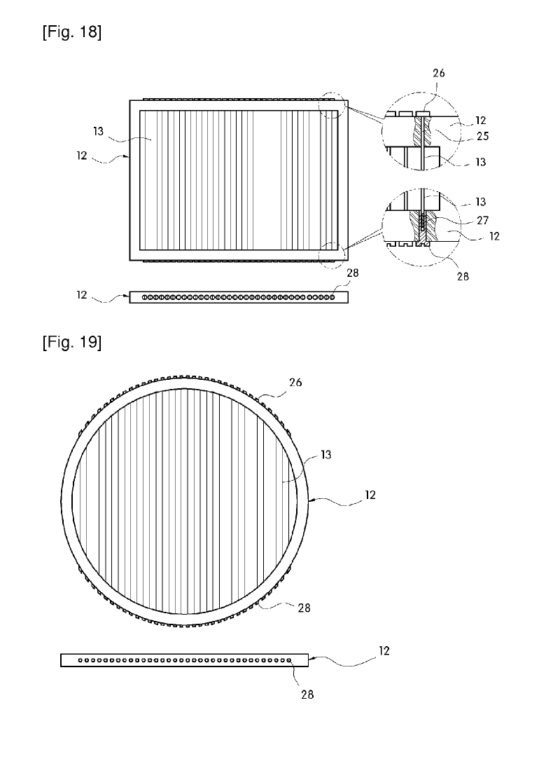

FIGS. 18 and 19 are schematic diagrams of a grill according to a seventh preferred embodiment of the present invention.

As shown in FIGS. 18 and 19, the grill according to the seventh preferred embodiment includes a grill frame 12 of a rectangular or a round shape, and a plurality of holes 25 formed in two opposite sides or in specific opposite sections of the grill frame 12 at regular intervals.

Additionally, the wire 13 includes a head portion 26 formed at one end thereof in such a way as to have a head thicker than the diameter of the wire and a screw portion 27 formed at the other end thereof.

In this instance, the head portion of the wire may be formed by a head-forming process.

After the wire 13 of one strand is inserted into one hole 25 starting from the side where the screw portion 27 is located, the wire 13 is inserted into the hole 25 of the other side, and then, the screw portion 27 is fastened by a nut 28, so that the wire 13 is mounted on the grill frame 12 in the form that multiple strands are arranged side by side at regular intervals.

That is, the wire 13 is mounted in such a fashion that both end portions are caught between the grill frame 12 using the nut 28 fastened to the screw portion 27 and the head portion 26.

Through the above structure, the wire 13 can keep a tightened state by tightening the nut 28.

In this instance, for convenience in rotation and manipulation, the head portion of the nut 28 has a driver slot or takes a form that can be fastened by a wrench.

Also in the seventh preferred embodiment, the wire 13 may have a small diameter within a range of 0.1 mm to 2.0 mm, and be made of one of metal material, inorganic material containing fire-proof incombustible fiber, such as carbon fiber or glass fiber, and others.

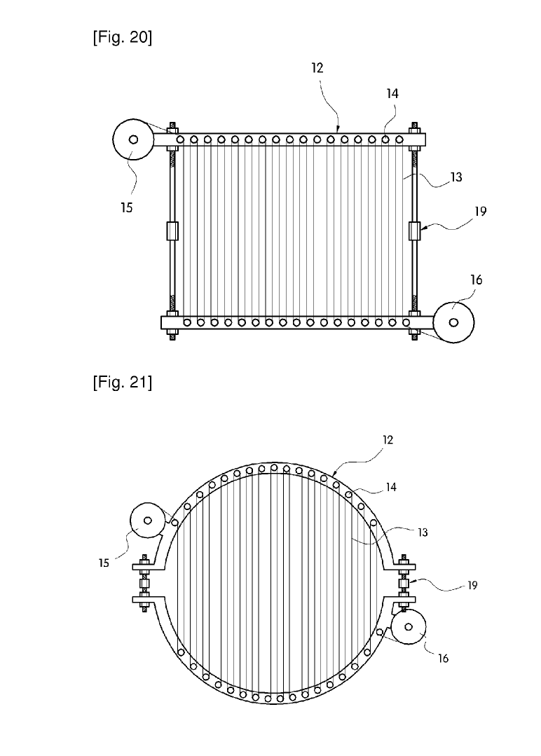

FIGS. 20 and 21 are schematic diagrams showing an example of a wire elasticity regulator of the grill according to the present invention.

As shown in FIGS. 20 and 21, the grill includes two divided grill frames 12 on which a wire 13 of one strand is caught to a plurality of support rods 14 formed on the divided grill frames 12, and the divided grill frames 12 are combined integrally in the form of a rectangular frame or a round frame through bolt-and-nut portions 19 fastened at both sides of the frames 12.

That is, end portions of the two divided grill frames 12 are fit to screw portions of elongated bolt members of the bolt-and-nut portions 19, and nut members are fastened to the fit portions, so that the two divided grill frames 12 can form one rectangular frame or a round frame through the two bolt-and-nut portions 19.

Each of the bolt-and-nut portions 19 includes: an elongated bolt member having screw portion formed at both ends thereof and a nut portion formed at the center thereof for allowing the user to manipulate; and a plurality of nut members fastened to the screw portions of the bolt member.

Accordingly, after the user releases the nut member of the bolt-and-nut portion 19 and widens a distance between the two divided grill frames 12, when the user fastens the nut member, the wire 13 can be adjusted into a tightened state.

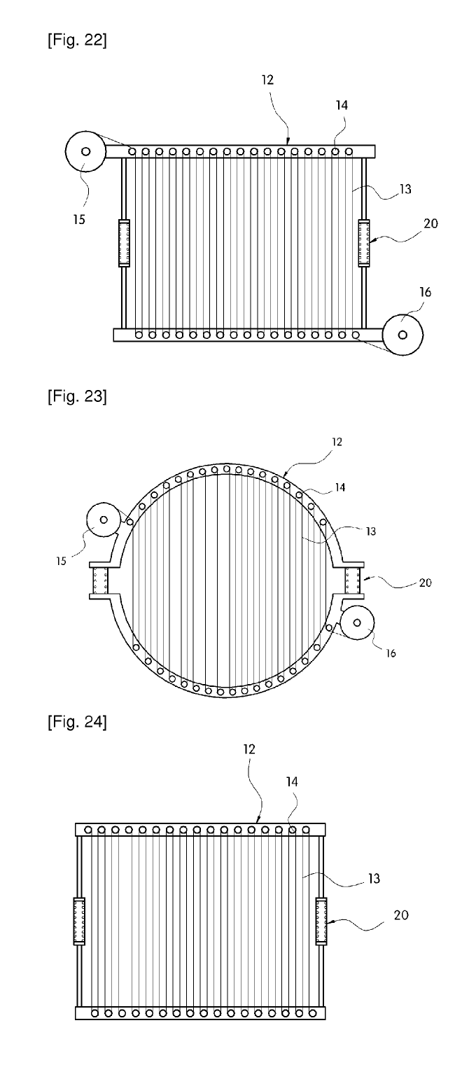

FIGS. 22 to 24 are schematic diagrams showing another example of a wire elasticity regulator of the grill according to the present invention.

FIGS. 22 to 24 illustrate an example that springs 20 are respectively connected to the two divided grill frames 12 so as to control elasticity of the wire 13.

In other words, the springs 20 are compression springs, and their ends are connected to end portions of the grill frames 12, so that the springs 20 can control elasticity of the wire while pushing the grill frames 12 with a proper power.

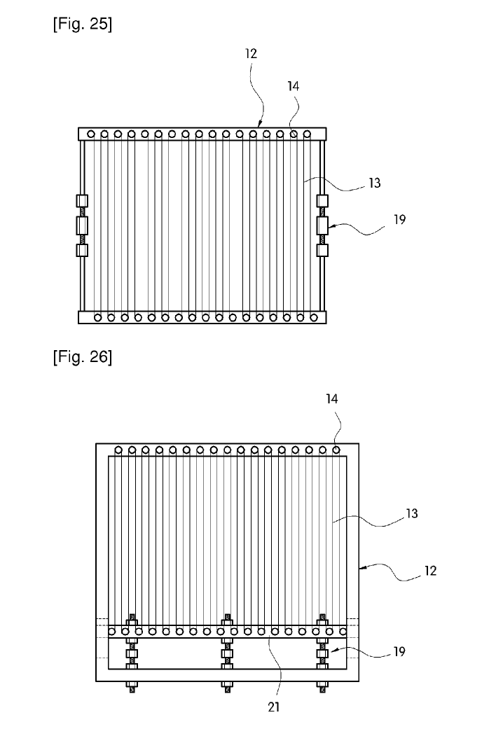

FIG. 25 is a schematic diagram showing a further example of the wire elasticity regulator of the grill according to the present invention.

FIG. 25 illustrates a wire elasticity regulator using a new type of bolt-and-nut portions 19.

Wires 13 of multiple strands may be arranged side by side between the two divided grill frames 12, or a wire 13 of one strand taking the form that multiple strands are arranged side by side because the wire 13 is connected to the grill frame 12 in a zigzag pattern may be arranged. Moreover, between the two divided grill frames 12, a pair of bolt-and-nut portions 19 are connected and mounted.

Each of the bolt-and-nut portions 19 includes a bolt member having screw portions, which are respectively formed at both end portions thereof and have different spiral directions from each other, and a nut member joined to the bolt member and fixed to the end portion of the grill frame 12.

Accordingly, when the bolt member is rotated in a forward direction, the two divided grill frames 12 are widened at the same time, but when the bolt member is rotated in a backward direction, the two divided grill frames 12 are narrowed at the same time, so that elasticity of the wire 13 can be effectively controlled.

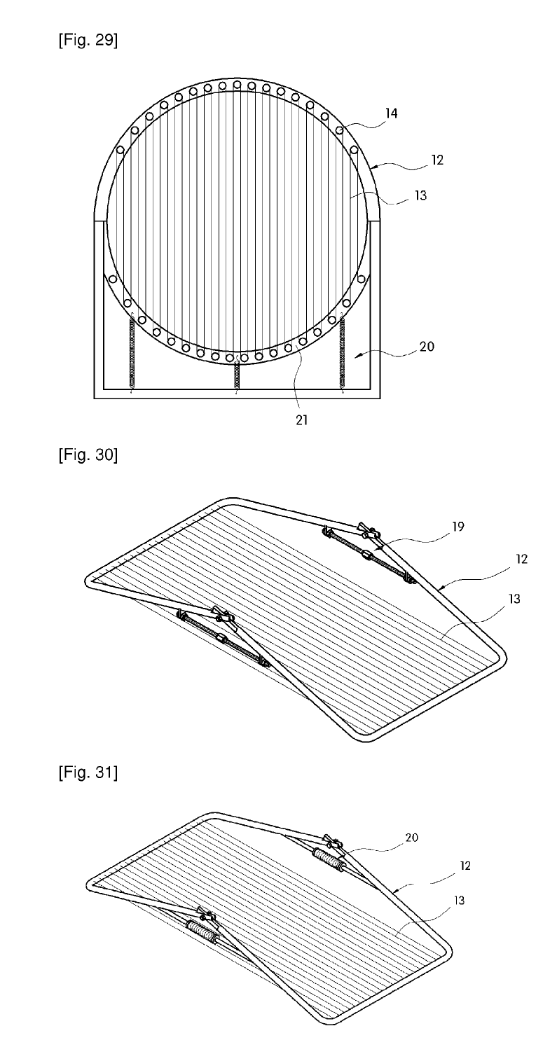

FIGS. 26 and 27 and FIGS. 28 and 29 are schematic diagrams showing a still further example of the wire elasticity regulator of the grill according to the present invention.

FIGS. 26 to 29 illustrate an example that elasticity of the wire 13 is controlled using an auxiliary bar 21.

Inside the grill frame 12 of a rectangular shape or a round shape, the auxiliary bar 21 for holding one side of the wires 13 of multiple strands is disposed in parallel with one side of the grill frame 12, and in this instance, the auxiliary bar 21 is mounted in parallel with the wire 13 in a back and forth movable manner.

Here, in the case of the round-shaped grill frame 12, the auxiliary bar 21 is not provided separately, but may take a round structure integrated with the grill frame.

Furthermore, a bolt-and-nut portion 19 or a spring 20, for instance, a tension spring, for controlling elasticity may be mounted between the auxiliary bar 21 and the side of the grill frame 12 adjacent to the auxiliary bar 21.

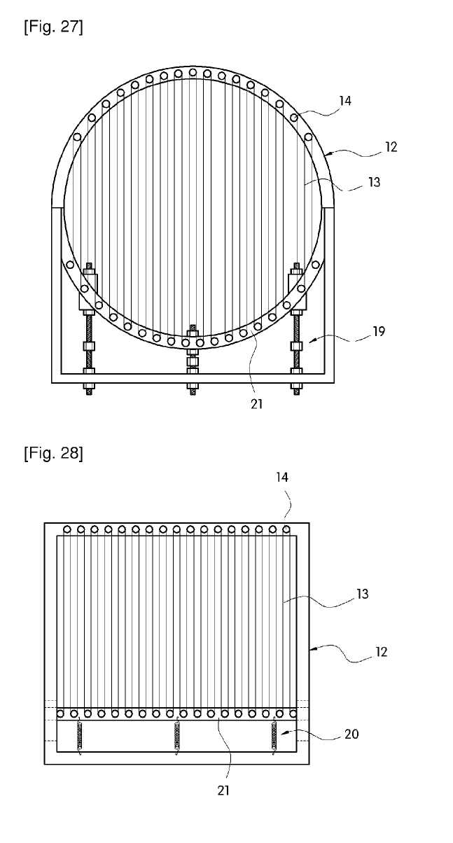

Therefore, in the case that the elasticity regulator is the bolt-and-nut portion 19 (see FIGS. 26 and 27), elasticity of the wire 13 can be controlled by pulling the auxiliary bar 21 to one side while controlling a fastened level. In the case that the elasticity regulator is the tension spring, the elasticity of the wire 13 can be controlled by pulling the auxiliary bar 21 by a spring force.

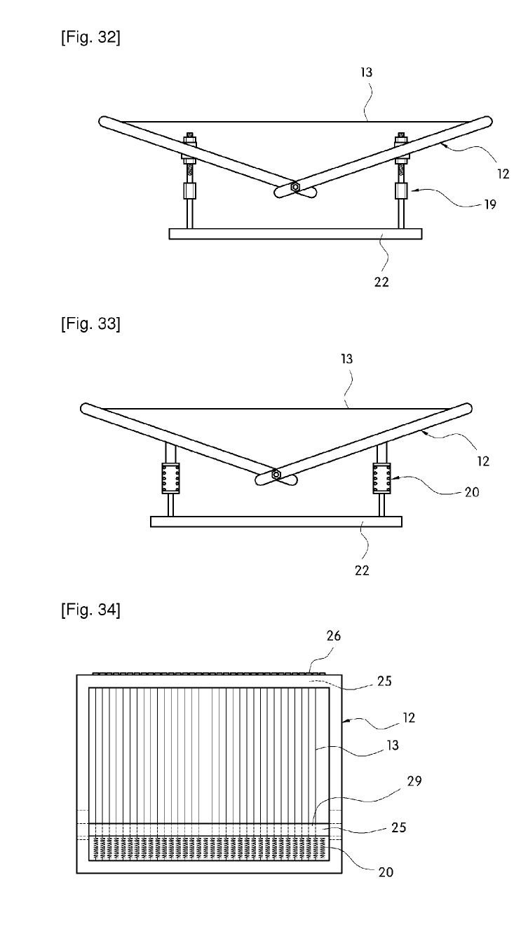

FIGS. 30 and 31 are schematic diagrams showing a further example of the wire elasticity regulator of the grill according to the present invention.

As shown in FIGS. 30 and 31, the two divided grill frames 12 are connected with each other by hinges in a state where they are inclined at predetermined angles, and a bolt-and-nut portion 19 or a spring 20, for instance, a tension spring, is connected between the two divided grill frames 12.

Accordingly, in the case that the elasticity regulator is the bolt-and-nut portion 19 (See FIG. 30), the bolt member having a left-handed screw and a right-handed screw at both sides is rotated so that elasticity of the wire 13 can be controlled by widening the distance between the grill frames 12. Moreover, in the case that the elasticity regulator is the compression spring (See FIG. 31), the two divided grill frames are widened by a pushing power of the spring so that elasticity of the wire 13 can be controlled.

FIGS. 32 and 33 are schematic diagrams showing a still further example of the wire elasticity regulator of the grill according to the present invention.

FIGS. 32 and 33 illustrate an example of wire elasticity regulator utilizing a support 22 serving as a leg.

The grill includes the support 22 disposed separately and two divided grill frames 12 which are inclined at predetermined angles and are connected with each other by hinges.

A bolt-and-nut portion 19 or a spring 20, for instance, a tension spring, is connected between the two divided grill frames 12 and the support 22.

Accordingly, in the case that the elasticity regulator is the bolt-and-nut portion 19 (See FIG. 32), the bolt member having a left-handed screw and a right-handed screw at both sides is rotated so that elasticity of the wire 13 can be controlled by ascending or descending the divided grill frames 12. Moreover, in the case that the elasticity regulator is the compression spring (See FIG. 33), the two divided grill frames are widened by a pulling power of the spring so that elasticity of the wire 13 can be controlled.

FIG. 34 is a schematic diagram of a grill according to an eighth preferred embodiment of the present invention.

As shown in FIG. 34, a plurality of holes 25 are formed in two opposite sides of the grill frame 12 of the rectangular shape along the longitudinal direction of the sides and are spaced apart at regular intervals. Inside the grill frame 12, a spring support frame 26 having holes 25 corresponding to the holes 25 of the grill frame 12 is mounted adjacent to the side of the grill frame and in parallel with the side of the grill frame 12.

Furthermore, the wire 13 has a head portion 26 formed at one side and a spring 20 mounted at the other side thereof.

In this instance, the wire 13 has multiple strands arranged side by side at regular intervals.

The wire 13 passes through the spring support frame 26 after being inserted into the hole 25 of one side of the grill frame starting from the side where the spring 20 is located, and then, the wire 13 of the spring side is inserted and fixed into the hole 25 of the opposite side.

So, the wire 13 can control elasticity by a pulling power of the tension spring.

Here, the wire 13 may have a diameter ranging from 0.1 mm to 2.0 mm, and may be made of a metal material or an inorganic material.

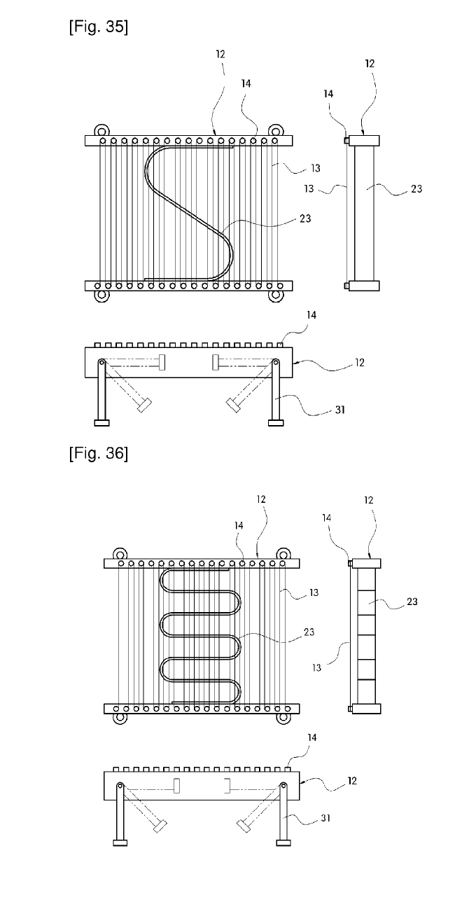

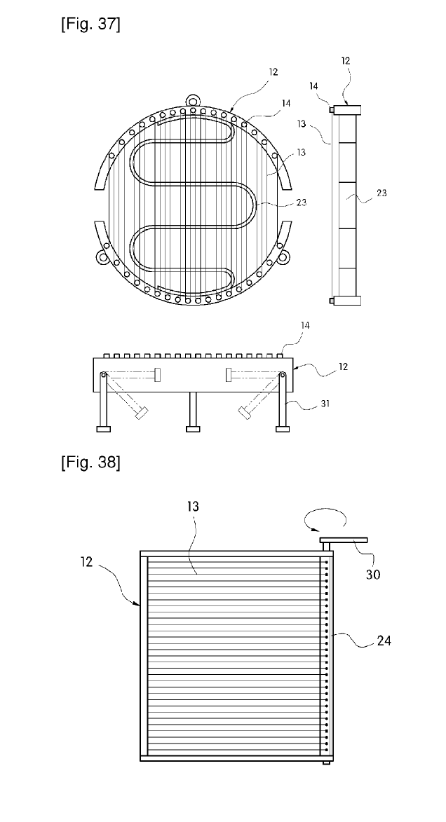

FIGS. 35 to 37 are schematic diagrams showing another example of the wire elasticity regulator of the grill according to the present invention.

FIGS. 35 to 37 illustrate an example that elasticity of the wire is controlled using a thermal expansion material.

The grill includes two divided grill frames 12, a wire 13 mounted between the two divided grill frames 12, and a thermal expansion material 23 which has a predetermined shape and is connected between the two divided grill frames.

In this instance, the thermal expansion material 23 may be located under the wire 13, and may be formed in an “S” shape or in a repeated “S” shape.

Accordingly, because the thermal expansion material, which is greater in thermal expansion than the grill frames 12 and the wire 13, is mounted inside the grill frame 12 toward a heat source, when the thermal expansion material is thermally expanded and pushes out the grill frames 12 while grilling, the wire 13 is pulled so that the wire 13 can keep the tightened state.

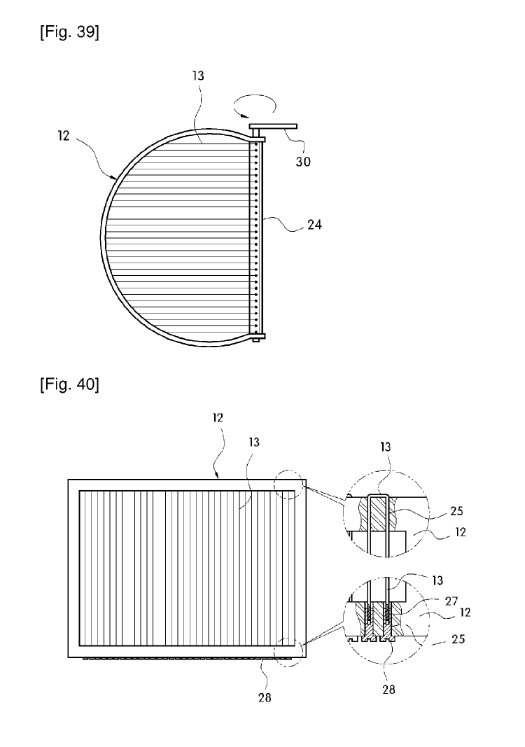

FIGS. 38 and 39 are schematic diagrams showing a further example of the wire elasticity regulator of the grill according to the present invention.

As shown in FIGS. 38 and 39, a rotational bar 24 is located at one side of the grill frame 12 in such a way that both ends of the rotational bar 24 are supported to the grill frame 12, and one side of the wire 13 is wound on the rotational bar 24.

In this instance, the rotational bar 24 includes nuts disposed at both ends of the rotational bar 24 for fastening the rotational bar 24 and a concave circumferential face on which the wire 13 is wound.

Accordingly, when the user rotates the rotational bar 24 using the handle 30, the wire 13 is pulled to be tightened, and after that, when the user fastens the nut, the wire 13 can keep the tightened state.

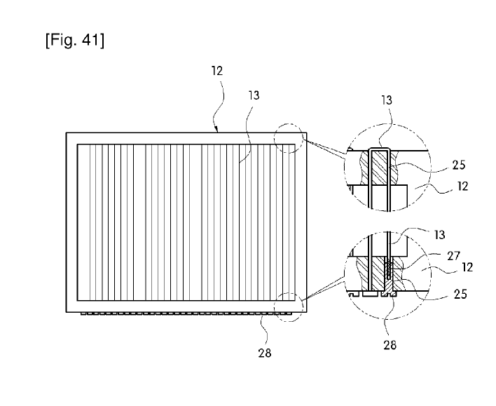

FIGS. 40 and 41 are schematic diagrams of a grill according to a ninth preferred embodiment of the present invention.

As shown in FIGS. 40 and 41, a plurality of holes 25 are formed in two opposite sides of the grill frame 12 of the rectangular shape along the longitudinal direction of the sides and are spaced apart at regular intervals, and the wire 13 is curved in the form of a “ [symbol] ” shape so as to form two rows.

In addition, the wire 13 may have screw portions 27 formed at both end portions thereof, or may have a head portion 26 formed at one end portion thereof and a screw portion 27 formed at the other end portion thereof.

After end portions of the wire 13 of the “ [symbol] ” shape are simultaneously inserted into two neighboring holes 25 of two sides of the grill frame 12, one end portion is caught to the hole 25 by the head portion 26 and a nut 28 is joined to the other end portion, namely, the screw portion 27, or nuts 28 are fastened to all of the screw portions 27 formed at both end portions of the wire 13.

In other words, inside the grill frame 12, the wires of multiple strands each forming the two rows are arranged side by side at regular intervals.

The wire 13 mounted as the above can be controlled in elasticity by the nut 28 joined to the screw portion 27.

Also in this embodiment, the wire 13 may have a small diameter within a range of 0.1 mm to 2.0 mm, and be made of one of metal material, inorganic material containing fire-proof incombustible fiber, such as carbon fiber or glass fiber, and others.

1. A grill comprising:
a grill frame of a rectangular shape having two opposite rotary shafts and two support frames for supporting both ends of the rotary shafts;
wires of multiple strands, each of the wires having one side wound on one of the rotary shafts several times and the other side fixed to the other one of the rotary shafts, the wires of multiple strands being arranged side by side at regular intervals,
wherein the wire is moved to and wound on any one side when a user manipulates the rotary shaft in the case that the wires are polluted, so that the wires are replaced with clean wires.

2. The grill according to claim 1, wherein the rotary shaft includes fixed portions formed in both side sections and a rotational portion formed in a central section between the side sections, so that just the wire wound on the rotational portion where heat is concentrated is replaceable.

3. The grill according to claim 1, wherein the wire has a diameter ranging from 0.1 mm to 2.0 mm.

4. A grill comprising:
a grill frame of a rectangular shape having a plurality of support rods arranged and spaced apart from one another at regular intervals along the longitudinal direction of two opposite sides; and
a wire of one strand caught to the support rods, which are located at the two sides of the grill frame, in a zigzag pattern while advancing from one side to the other side of the grill frame so that the wire shows a form that many strands are arranged side by side at regular intervals.

5. The grill according to claim 4, wherein in the case that the grill frame is formed in a round shape, a plurality of the support rods are mounted on specific opposite sections of a round rim of the grill frame, and the wire of one strand is caught to the support rods of each section in a zigzag pattern while advancing from one side to the other side of the grill frame so that the wire shows a form that many strands are arranged side by side at regular intervals.

6. The grill according to claim 4, wherein the wire has a diameter ranging from 0.1 mm to 2.0 mm.

7. The grill according to claim 4, wherein the grill comprises a pair of grill frames, which are connected with each other by hinges in a foldable and unfoldable manner.

8. The grill according to claim 4, further comprising:
a rotational feeder mounted at one side of the grill frame for releasing and supplying the wire, and a rotational winder mounted at the other side of the grill frame for winding and withdrawing the wire.

9. The grill according to claim 1, further comprising:
a wire elasticity regulator for regulating elasticity of the wire.

10. The grill according to claim 9, wherein the wire elasticity regulator adopts a method of regulating a bolt-and-nut portion for connecting two divided grill frames with each other.

11. The grill according to claim 9, wherein the wire elasticity regulator adopts a method of using tension of a spring for connecting two divided grill frames with each other.

12. The grill according to claim 9, wherein the wire elasticity regulator comprises a thermal expansion material connected and mounted between two grill frames, which are arranged side by side with each other, so as to be expanded and contracted at the time of supply and radiation of heat.

13. The grill according to claim 9, wherein the wire elasticity regulator comprises a rotational bar provided in place of one side of the grill frame of a rectangular shape, and one side of wires of multiple strands is connected to the rotational bar and the wires are wound on the rotational bar.

14. A grill comprising:
a grill frame of a rectangular shape having a plurality of holes, which are formed in two opposite sides in a longitudinal direction of the sides and spaced apart from one another at regular intervals; and
wires of multiple strands, each having a head portion formed at one end portion and a screw portion formed at the other end portion thereof, the wires being inserted into the holes of the two sides of the grill frame and fixed when nuts are fastened to the screw portions, so that the wires are arranged side by side at regular intervals.

15. The grill according to claim 14, wherein the wire has a diameter ranging from 0.1 mm to 2.0 mm.

16. A grill comprising:
a grill frame of a rectangular shape having a plurality of holes, which are formed in two opposite sides in a longitudinal direction of the sides and spaced apart from one another at regular intervals, and a spring support frame arranged adjacent to and side by side with the side where the holes are formed; and
wires of multiple strands, each having a head portion formed at one end portion and a spring formed at the other end portion thereof, the wires passing through the spring support frame and being inserted and fixed into the holes of the two sides of the grill frame, so that the wires are arranged side by side at regular intervals,
wherein elasticity of the wires is regulated using tension of the spring.

17. The grill according to claim 16, wherein the wire has a diameter ranging from 0.1 mm to 2.0 mm.

18. A grill comprising:
a grill frame of a rectangular shape having a plurality of holes, which are formed in two opposite sides in a longitudinal direction of the sides and spaced apart from one another at regular intervals; and
wires of multiple strands, each wire being curved in the form of a “ [symbol] ” shape so as to form two rows and including screw portions formed at both end portions thereof or including a head portion formed at one end portion thereof and a screw portion formed at the other end portion thereof, the wires being inserted into two neighboring holes of two sides of the grill frame and fixed by nuts fastened to the screw portions protruding outwardly, so that the wires (are arranged side by side at regular intervals.

19. The grill according to claim 18, wherein the wire has a diameter ranging from 0.1 mm to 2.0 mm.

20. A grill comprising:
a grill frame of a rectangular or round shape; and
wires of multiple strands arranged inside the grill frame side by side in one direction and spaced apart from one another at regular intervals, the wires having both ends fixed to the grill frame and having a diameter ranging from 0.1 mm to 2.0 mm.
